(19) United States
(12) Patent Application Publication
(10) Pub. No.: US 2018/0044184 A1
(43) Pub. Date: Feb. 15, 2018

(54) CARBON-NANOTUBE-ELASTOMER COMPOSITE MATERIAL AND SEALING MATERIAL AND SHEET MATERIAL EMPLOYING SAME

(71) Applicant: NATIONAL INSTITUTE OF ADVANCED INDUSTRIAL SCIENCE AND TECHNOLOGY,, Tokyo (JP)

(72) Inventors: Seisuke ATA, Tsukuba-shi (JP); Kenji HATA, Tsukuba-shi (JP); Shigeki TOMONOH, Tsukuba-shi (JP)

(21) Appl. No.: 15/551,412

(22) PCT Filed: Feb. 19, 2016
(86) PCT No.: PCT/JP2016/054861

§ 371 Date: Aug. 16, 2017

(30) Foreign Application Priority Data
Feb. 19, 2015 (JP) 2015-031161

(51) Int. Cl. C01B 32/164; C08K 7/28; C08K 3/04; B82Y 30/00

(52) U.S. Cl. CPC C01B 32/164; B82Y 30/00; C08K 7/28; C08K 3/04; C01B 32/166

(57) ABSTRACT

A carbon nanotube-elastomer composite material according to the present invention contains carbon nanotubes and an elastomer, which contains the carbon nanotubes in a range of 0.1 part by weight to 20 parts by weight relative to the total weight of the carbon nanotubes and the elastomer, and in which the elastomer has a thermal decomposition temperature of 150° C. or more, and supposing that the resulting storage modulus is E′(t) when the carbon nanotube-elastomer composite material is maintained at 150° C. for t hours, a ratio E′ (24)/E′(0) between a storage modulus E′ (0) at the time of t=0 hour and a storage modulus E′(24) at the time of t=24 hours is set in a range from 0.5 or more to 1.5 or less in the resulting carbon nanotube-elastomer composite material.

### CROSS REFERENCE TO RELATED APPLICATIONS

This application is based upon and claims the benefit of priority from the prior Japanese Patent Application No. 2015-031161, filed on Feb. 19, 2015, and PCT Application No. PCT/JP2016/054861, filed on Feb. 19, 2016, the entire contents of which are incorporated herein by reference.

### FIELD

The present invention relates to a carbon nanotube-elastomer composite material and a sealing material and a sheet material each produced using the same. In particular, the present invention relates to such a carbon nanotube-elastomer composite material that has heat resistance and can be continuously used under high temperatures, and a sealing material and a sheet material each produced using the same.

### BACKGROUND

The elastomer, which is soft and exhibits rubber elasticity, has been used in a wide range of applications, such as a sealing material, an absorber and the like. However, the elastomer is not a material having sufficient heat resistance, and its use range and use environment are limited. With respect to the heat resistant limit of generally used elastomers, it is 120° C. in natural rubber, 150° C. in butyl rubber and 300° C. in fluoro-rubber; however, since these are softened when continuously used, it is difficult to use these, for example, as sealing materials under high temperatures.

By combining the elastomer with a filler, such as, for example, carbon nanotubes (hereinafter, referred to also as CNT) as a composite component, the heat resistance of the elastomer can be improved. For example, Patent Publication No. 2010-507110 has reported that by making CNT having a large diameter, carbon black and an elastomer combine with one another, its heat resistance can be improved. Moreover, Patent Publication No. 2007-39648 has described a fiber composite material which contains an elastomer, carbon nanofibers having an average diameter in a range of 0.7 to 15 nm and an average length in a range of 0.5 to 100 μm, dispersed in the elastomer, and fibers having an average diameter in a range of 1 to 100 μm and an aspect ratio in a range of 50 to 500, and in which the elastomer has an unsaturated bond or a group having an affinity to the carbon nanofibers. Patent Publication No. 2009-161652 has described a carbon fiber composite material which contains 5 to 40 parts by weight of vapor-phase epitaxial growth carbon fibers having an average diameter in a range exceeding 30 nm to 200 nm or less, relative to 100 parts by weight of fluorine-containing elastomer, and has a breaking elongation (EB) at 23° C. of 200% to 500%, a dynamic elastic modulus at 30° C. (E′/30° C.) in range of 25 MPa to 3000 MPa and a dynamic elastic modulus at 250° C. (E′/250° C.) in range of 15 MPa to 1000 MPa.

However, in these conventional techniques also, a composite material between the CNT and an elastomer that is less susceptible to physical property changes even when used continuously at high temperatures has not been reported. If a heat resistant carbon nanotube-elastomer composite material that has little physical property changes even when continuously used under high temperatures can be realized, this material can be really desirably used for the application of a sealing material or the like.

### SUMMARY

The present invention, which has been devised to solve the above-mentioned conventional problems, provides a carbon nanotube-elastomer composite material that improves the heat resistance of an elastomer and can be continuously used at a temperature of 150° C. or more for 24 hours or more, and a sealing material and a sheet material each produced using the same.

In accordance with an embodiment of the present invention, a carbon nanotube-elastomer composite material containing carbon nanotubes and an elastomer, which contains the carbon nanotubes in a range of 0.1 part by weight to 20 parts by weight relative to the total weight of the carbon nanotubes and the elastomer, and in which the elastomer has a thermal decomposition temperature of 150° C. or more, and supposing that the resulting storage modulus is E′(t) when the carbon nanotube-elastomer composite material is maintained at 150° C. for t hours, a ratio E′ (24)/E′(0) between a storage modulus E′ (0) at the time of t=0 hour and a storage modulus E′(24) at the time of t=24 hours is set in a range from 0.5 or more to 1.5 or less in the resulting carbon nanotube-elastomer composite material, is provided.

In the above-mentioned carbon nanotube-elastomer composite material, a radical concentration of the carbon nanotube-elastomer composite material is obtained by maintaining the carbon nanotube-elastomer composite material for 10 minutes at either of a lower temperature between 280° C. and a temperature subtracting 50° C. from a thermal decomposition temperature of the elastomer and measuring by an electron spin resonance method, and a value, which is obtained by dividing the radical concentration by a radical concentration obtained by measuring the nanotube-elastomer composite material by the electron spin resonance method after a lapse of 10 minutes from the time at which the carbon nanotube-elastomer composite material has been returned to room temperature, may be set to 0.8 or more.

Moreover, in accordance with the embodiment of the present invention, a carbon nanotube-elastomer composite material containing carbon nanotubes and an elastomer, in which the carbon nanotubes are contained in an amount from 0.1 part by weight or more to 20 parts by weight or less relative to the total weight of the carbon nanotubes and the elastomer and in which the elastomer has a thermal decomposition temperature of 150° C. or more, and in which a radical concentration of the carbon nanotube-elastomer composite material is obtained by maintaining the carbon nanotube-elastomer composite material for 10 minutes at either of a lower temperature between 280° C. and a temperature subtracting 50° C. from a thermal decomposition temperature of the elastomer and measuring by an electron spin resonance method and a value, which is obtained by dividing the radical concentration by a radical concentration obtained by measuring the nanotube-elastomer composite material by the electron spin resonance method after a lapse of 10 minutes from the time at which the carbon nanotube-elastomer composite material has been returned to room temperature, is set to 0.8 or more, is provided.

In the above-mentioned carbon nanotube-elastomer composite material, the tensile strength measured in a tensile strength test (in compliance with JIS K6251) at 150° C. of the carbon nanotube-elastomer composite material may be set to 1.0 MPa or more.

When the above-mentioned carbon nanotube-elastomer composite material is heated by a dynamic mechanical characteristic measuring device from room temperature at a rate of 10° C./min, the storage modulus at 150° C. may be set to 0.5 MPa or more, and the loss tangent thereof may be set to 0.5 MPa or less.

In the carbon nanotube-elastomer composite material, in a range from room temperature to 150° C., it may have a linear expansion coefficient of 5×10⁻⁴/K or less.

When measured by a differential scanning calorimeter, the carbon nanotube-elastomer composite material may have a glass transition temperature measured by differential scanning calorimetry in a range from −50° C. or more to 10° C. or less.

In the carbon nanotube-elastomer composite material, the carbon nanotubes may have a specific surface area of 200 m²/g or more.

In the carbon nanotube-elastomer composite material, the diameter of the carbon nanotubes may be set to 20 nm or less.

In the carbon nanotube-elastomer composite material, the number of layers in each of the carbon nanotubes may be set to 10 or less.

When maintained at 500° C. for 6 hours or more under a nitrogen atmosphere, the above-mentioned carbon nanotube-elastomer composite material has its residual carbon nanotubes formed a structure, and a ratio of the bulk volume of the structure of the residual carbon nanotubes after the burning process relative to the volume of the carbon nanotube-elastomer composite material before the burning process may be set to 0.5 or more.

In the carbon nanotube-elastomer composite material, the structure of the residual carbon nanotubes may have a pore distribution having one or more peaks in a range of 1 nm or more to 100 μm or less.

Moreover, in accordance with another embodiment of the present invention, a sealing material includes the above-mentioned carbon nanotube-elastomer composite material described in any one of the above descriptions is provided.

Furthermore, in accordance with the other embodiment of the present invention, a sheet material includes the above-mentioned carbon nanotube-elastomer composite material described in any one of the above descriptions is provided.

### BRIEF DESCRIPTION OF DRAWINGS

FIG. 1A is a schematic view that shows a carbon nanotube-elastomer composite material 100 in accordance with one embodiment of the present invention, shows a cross-sectional view showing one portion of the carbon nanotube-elastomer composite material 100;

FIG. 1B shows a schematic view showing a structure obtained after burning the carbon nanotube-elastomer composite material 100,

FIG. 2 is a schematic view showing a state in which radicals are adsorbed onto CNTs in the carbon nanotube-elastomer composite material 100 relating to the embodiment of the present invention; and

FIG. 3 is a table showing characteristics of the carbon nanotube-elastomer composite material relating to the embodiment of the present invention.

### REFERENCE SIGNS LIST

10 . . . CNT, 30 . . . elastomer, 50 . . . CNT structure, 100 . . . carbon nanotube-elastomer composite material, 150 . . . thermal radical

### DESCRIPTION OF EMBODIMENTS

Referring to Figures, the following description will explain a carbon nanotube-elastomer composite material in accordance with the present invention and a sealing material and a sheet material each produced using the same. Additionally, the carbon nanotube-elastomer composite material in accordance with the present invention and a sealing material and a sheet material each produced using the same should not be restrictively interpreted based upon embodiments and the contents of examples shown below. Additionally, in the Figures to be referred to in the present embodiment and examples to be described later, the same parts and parts having the same functions are indicated by the same reference numeral and repetitive explanations thereof will be omitted.

The carbon nanotube-elastomer composite material relating to the present invention is a composite material including carbon nanotubes (CNT) and an elastomer, which is less susceptible to thermal decomposition, composition deformation and physical property changes, even when continuously used at a high temperature of 150° C. or more.

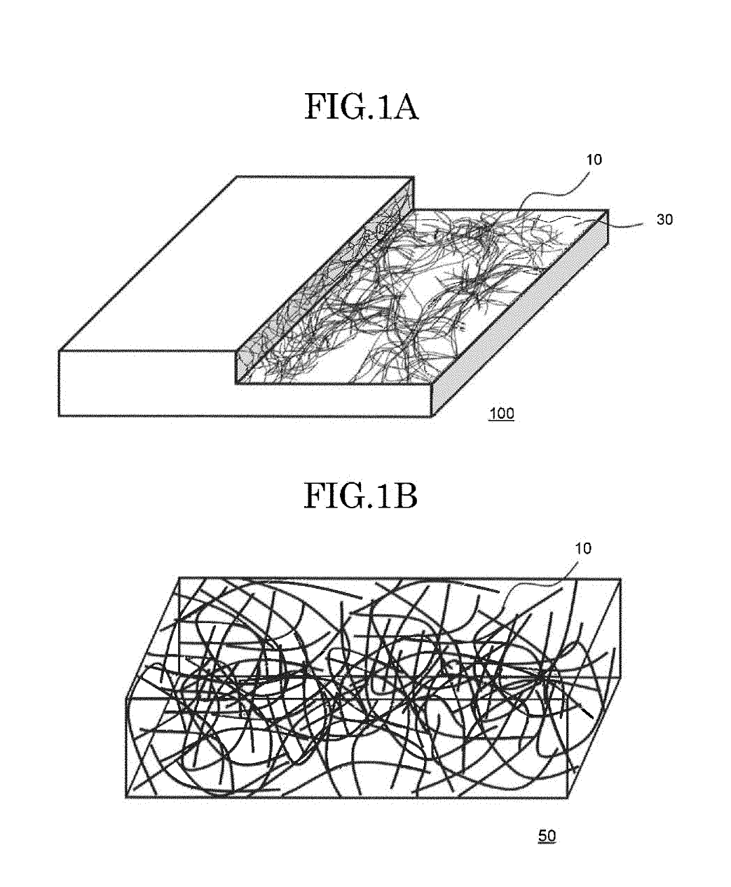

FIGS. 1A and 1B are schematic views showing a carbon nanotube-elastomer composite material 100 relating to one embodiment of the present invention. FIG. 1A is a cross-sectional view showing one portion of the carbon nanotube-elastomer composite material 100, and FIG. 1B is a schematic view showing a structure formed after burning the carbon nanotube-elastomer composite material 100. The carbon nanotube-elastomer composite material 100 contains CNT 10 and an elastomer 30, and the CNTs 10 are highly fibrillated in the elastomer 30 to form a network structure with the CNTs 10 being made in contact with one another.

The CNTs 10 contained in the carbon nanotube-elastomer composite material 100 relating to the embodiment of the present invention have a structure in which CNTs 10 are fibrillated from a bunch (bundle) of CNTs 10. In the carbon nanotube-elastomer composite material 100, the fibers of CNTs 10 are physically entangled with one another to form a continuous network that is highly developed. Moreover, the distance between entangled points among mutual fibrillated CNTs 10 is set to be 1 μm or more. By having this structure, the carbon nanotube-elastomer composite material 100 relating to the present invention makes it possible to improve the heat resistance of the elastomer, and consequently to be continuously used for 24 hours or more at a temperature of 150° C. or more.

In the embodiment, the carbon nanotube-elastomer composite material 100 contains CNTs in a range from 0.1 parts by weight or more to 20 parts by weight or less, preferably, from 0.3 parts by weight or more to 10 parts by weight or less, more preferably, from 0.5 parts by weight or more to 15 parts by weight or less, relative to the total weight of the carbon nanotube-elastomer composite material 100. When the content of the CNTs is 0.1 parts by weight or less, it is not possible to impart continuous heat resistance under a high-temperature environment to the carbon nanotube-elastomer composite material 100. Moreover, when the content of the CNTs is greater than 20 parts by weight, the viscoelasticity inherent to the elastomer is not sufficiently exerted, with the result that when used as a sealing material and a sheet-shaped material, required flexibility and following property cannot obtained, causing an undesirable state.

In accordance with one embodiment, in the carbon nanotube-elastomer composite material 100, the elastomer has a thermal decomposition temperature (T_{G}) of 150° C. or more, preferably, 200° C. or more, more preferably, 250° C. or more, and further more preferably, 300° C. or more. The upper limit of the thermal decomposition temperature of the elastomer used in the present invention is not particularly limited. When the thermal decomposition temperature of the elastomer is higher than 150° C., deterioration in physical properties of the elastomer due to thermal decomposition under a high temperature is suppressed, making it possible to impart continuous heat resistance to the carbon nanotube-elastomer composite material 100 so that this is desirably used for a sealing material and a sheet material to be used under high temperatures. In this case, in the present specification, the thermal decomposition temperature (T_{G}) of the elastomer can be measured by using a calorimeter measuring device. Detailed measuring conditions will be described later.

Moreover, in another embodiment, supposing that a storage modulus at the time when the carbon nanotube-elastomer composite material is maintained at 150° C. fort hours is E′(t), a ratio E′(24)/E′(0) between a storage modulus E′(0) at the time of t=0 and a storage modulus E′(24) at the time of t=24 hours is set to 0.1 or more to 3.0 or less, preferably, to 0.5 or more to 2.0 or less, more preferably, to 0.7 or more to 1.3 or less, further more preferably in a range from 0.9 or more to 1.1 or less. When the ratio between before and after the holding process at a high temperature is less than 0.5, the elastomer causes thermal deterioration, failing to be used as a sealing material; thus, this material is not desirable. When the ratio between before and after the holding process at a high temperature is higher than 1.5, the elastomer is thermally cured, failing to be used as a sealing material; thus, this material is not desirable.

The carbon nanotube-elastomer composite material 100 makes it possible to set the ratio E′(24)/E′(0) in the above-mentioned ranges at a high temperature in a range of, preferably, 200° C. or more, more preferably, 250° C. or more, and further more preferably, 300° C. or more. In the present embodiment, even when the holding time t is preferably set to 48 hours or more, more preferably to 72 hours or more, the ratio of elastic moduli can be set in these ranges.

Furthermore, in still another embodiment, in the carbon nanotube-elastomer composite material 100, a radical concentration of the carbon nanotube-elastomer composite material 100 is obtained by maintaining the carbon nanotube-elastomer composite material for 10 minutes at either of a lower temperature between 280° C. and a temperature subtracting 50° C. from a thermal decomposition temperature of the elastomer (the thermal decomposition temperature of the elastomer—50° C.) and measuring by an electron spin resonance method, and a value, which is obtained by dividing the radical concentration by a radical concentration obtained by measuring the nanotube-elastomer composite material 100 by the electron spin resonance (ESR) method after a lapse of 10 minutes from the time at which the carbon nanotube-elastomer composite material 100 has been returned to room temperature, is set to 0.8 or more, preferably, 0.85 or more, more preferably, 0.9 or more, further more preferably 0.95 or more, and 1.0 or less.

In the carbon nanotube-elastomer composite material 100, thermal radicals causing thermal decomposition of the elastomer are fixed onto the CNTs and made no longer movable. Therefore, in the case when no CNT is contained therein, the thermal radicals are lost by association. However, in the case when CNTs are contained therein, the thermal radicals are captured onto the CNT surface after having moved through distances about the peak value of the pore size, and become no longer movable, with the result that the above-mentioned ratio of radical concentrations becomes closer to 1.0. When the ratio of radical concentrations becomes smaller than 0.8, the thermal radicals are not fixed onto the CNTs. Moreover, in the case when the ratio of radical concentrations exceeds 1.0, since many radicals are not generated at room temperature rather than at high temperatures, the ratio of thermal radical concentrations before and after the heating process is not set to 1 or more.

Moreover, when two thermal radicals are associated with each other, the thermal radicals are lost. On the other hand, when a thermal radical is stabilized on the CNT surface, the thermal radical is present stably, and is not lost. As the distance between CNTs becomes closer, the thermal radical is stabilized on the CNT surface with less moving distance (that is, with less moving time). The thermal radical deteriorates a high molecular substance to lower its physical properties; however, in the carbon nanotube-elastomer composite material 100 relating to the present invention, since thermal radicals generated by a heating process are stabilized on the surface of CNTs forming the network structure in a short period of time, it becomes possible to suppress thermal decomposition, composition deformation and physical property changes of the elastomer.

In the carbon nanotube-elastomer composite material 100 relating to the present invention having these characteristics, thermal radicals to cause thermal decomposition of the elastomer are captured by CNTs so that the thermal decomposition of the elastomer can be suppressed. For this reason, since the carbon nanotube-elastomer composite material 100 relating to the present invention is less susceptible to thermal decomposition and physical property changes, even when maintained at a high temperature of 150° C. or more, preferably, 200° C. or more, more preferably, 250° C. or more, and further more preferably, 300° C. or more, for 24 hours or more, preferably, 48 hours or more, and more preferably, 72 hours or more, this material is desirably applicable to continuous use under a high temperature.

In still another embodiment, the carbon nanotube-elastomer composite material 100, the tensile strength measured in a tensile strength test (in compliance with JIS K6251) at a temperature of 150° C. is set to 1 MPa or more, preferably, 5 MPa or more, and more preferably, 10 MPa or more, and also set to 100 MPa or less. In the case of the tensile strength smaller than 1 MPa, the resulting material exerts a liquid state characteristic. On the other hand, when the tensile strength is 1 MPa or more, the resulting material exerts rubber elasticity, and can be used as a sealing material. In the carbon nanotube-elastomer composite material 100 relating to the present invention, since radicals generated by the thermal decomposition of the elastomer are captured by the CNTs 10, rubber elasticity inherent to the elastomer can be maintained even under high temperatures.

In accordance with still another embodiment, when the carbon nanotube-elastomer composite material 100 is heated by a dynamic mechanical characteristic measuring device from room temperature at a rate of 10° C./min, the storage modulus at 150° C. is set to 0.5 MPa or more, preferably, 1 MPa or more, more preferably, in a range from 5 MPa or more to 100 MPa or less, and the loss tangent thereof is set to 0.5 or less, preferably, in a range of 0.1 or less to 0.001 or more. In the carbon nanotube-elastomer composite material 100 relating to the present invention, by setting the storage modulus and the loss tangent in these ranges, rubber elasticity inherent to the elastomer can be maintained even under high temperatures.

In accordance with still another embodiment, in a range from room temperature to 150° C., the carbon nanotube-elastomer composite material 100 has a linear expansion coefficient of 5×10⁻⁴/K or less, preferably, 2×10⁻⁴/K, and −1×10⁻⁴/K or more. In the carbon nanotube-elastomer composite material 100, a sealing material attached at room temperature is not slackened by a thermal expansion, and can be used even at high temperatures. As shown in FIG. 1A, in the carbon nanotube-elastomer composite material 100 relating to the present invention, since the CNTs having a linear negative thermal expansion coefficient form a CNT structure 50 forming a continuous network in the elastomer, the thermal expansion of the elastomer can be suppressed.

In still another embodiment, the glass transition temperature of the carbon nanotube-elastomer composite material 100 is set in a range from −50° C. or more to 10° C. or less, preferably, in a range from −50° C. or more to −10° C. or less. In the carbon nanotube-elastomer composite material 100 relating to the present invention, since the carbon nanotube-elastomer composite material 100 having such a glass transition temperature exerts rubber elasticity inherent to the elastomer at room temperature, it can be used as a sealing material or the like. In general, upon adding fillers to an elastomer, its glass transition temperature is raised by the suppression of molecular movements of elastomer molecules by the filler. In the carbon nanotube-elastomer composite material 100 relating to the present invention, since the CNT 10 does not suppress molecular movements of the elastomer, the change in the glass transition temperature by the addition of the CNT can be reduced.

### (Carbon Nanotube)

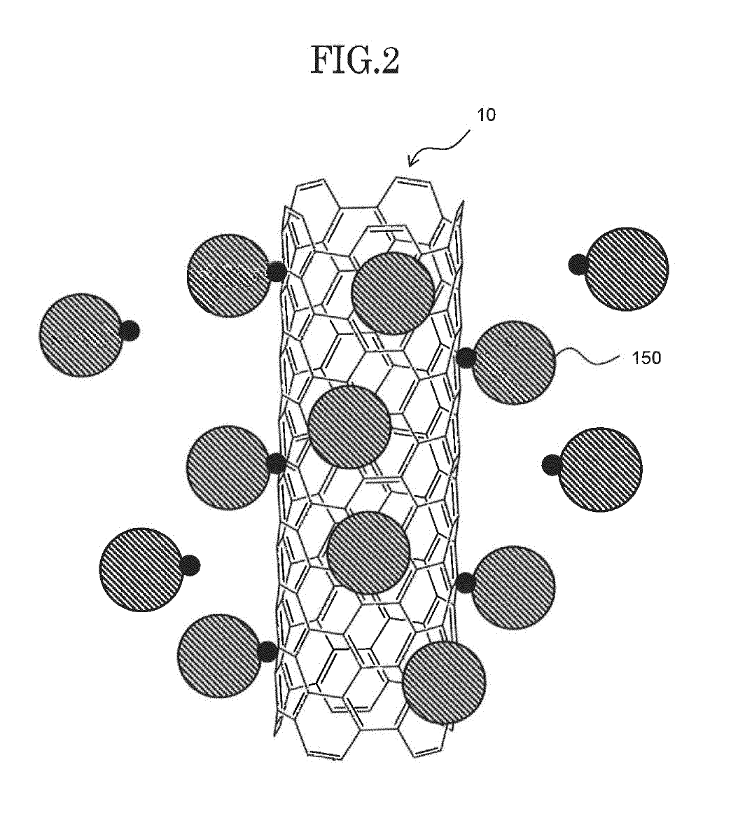

As shown in FIGS. 1A and 1B, the CNTs 10 contained in the carbon nanotube-elastomer composite material 100 allows the CNTs 10 to intersect with a plurality of the CNTs 10 so that a network structure combined with points by Van der Waals' forces is formed. Moreover, as shown in FIG. 2, in the carbon nanotube-elastomer composite material 100, the CNT 10 captures thermal radicals 150 generated at the time of heating the elastomer 30. The specific surface area of the CNT 10 contained in the carbon nanotube-elastomer composite material 100 has 200 m²/g or more, preferably 400 m²/g or more, more preferably 600 m²/g or more, and also has 2000 m²/g or less. Since the CNT 10 having such a large specific surface area can capture more thermal radicals 150 generated at the time of heating the elastomer 30, it becomes possible to improve the heat resistance of the carbon nanotube-elastomer composite material 100.

Moreover, the diameter of the CNT 10 is 20 nm or less, preferably, 10 nm or less, more preferably, 7 nm or less, further more preferably, 4 nm or less, and is 0.5 nm or more. Since the CNT 10 having such a small diameter makes it possible to provide a large specific surface area and also to capture more thermal radicals 150, it is possible to improve the heat resistance of the carbon nanotube-elastomer composite material 100.

Moreover, the number of layers of the CNT 10 has 10 layers or less, preferably 5 layers or less, more preferably 2 layers or less, and the most preferably a single-walled. In this case, the number of layers of the CNT corresponds to the average number of layers of 100 CNTs observed by a transmission type electron microscope (TEM), and the double-walled CNT refers to a CNT in which half or more of the entire CNTs have two layers, and the single-walled CNT refers to a CNT in which half or more of the entire CNTs have a single-walled. Since thermal radicals 150 generated at the time of heating the elastomer 30 are captured only by the outermost layer of the CNT, the CNT 10 having such a small number of layers makes it possible to capture more thermal radicals 150 so that it becomes possible to improve the heat resistance of the carbon nanotube-elastomer composite material 100.

By dispersing CNTs having such a small diameter and a large specific surface area densely in the elastomer, the thermal radicals can be effectively captured so that the heat resistance of the carbon nanotube-elastomer composite material 100 can be improved.

In still another embodiment, when the carbon nanotube-elastomer composite material 100 is maintained under a nitrogen atmosphere at 500° C. for 6 hours or more, the residual CNTs 10 form a CNT structure 50, and the ratio of the bulk volume of the CNT structure 50 formed with the residual CNTs 10 after the burning process relative to the volume of the carbon nanotube-elastomer composite material 100 before the burning process is set to 0.5 or more, preferably, 0.6 or more, more preferably, 0.7 or more, further more preferably, 0.8 or more, and the most preferably, 0.9 or more, and also set to 1.0 or less. When the elastomer 30 is sublimated under a nitrogen atmosphere, the residual CNTs do not come to pieces, and form a CNT structure 50 that has no volume change relative to the carbon nanotube-elastomer composite material. This means that inside the elastomer, the CNTs 10 are mutually made in contact with one another to form a network having a dynamically holding strength. This CNT structure 50 makes it possible to impart robustness to the elastomer 30 like reinforcing bars in concrete, as well as superior dynamical and chemical characteristics thereto.

The volume ratio of the CNT structure 50 may be measured by using any conventionally known method; however, it is desirable to carry out measuring processes in which the size of the CNT structure 50 is measured by a digital microscope, and by measuring the area from the upper surface and the thickness from the lateral direction, the bulk volume is found by the product of the bottom surface area and the height. Therefore, in the present specification, the CNT structure 50 is evaluated by the bulk volume, and is not calculated by integrating the volume of the CNTs 10.

In the case when the carbon nanotube-elastomer composite material 100 is maintained under a nitrogen atmosphere at 500° C. for 6 hours or more, with respect to the pore distribution in the residual CNT structure 50, one or more peaks are present in a range from 1 nm or more to 100 μm or less. In this case, the pore distribution can be measured by a porosimeter of mercury porosimetry. The peak corresponds to a point where the differential pore volume becomes 0, and also corresponds to a point where the differential pore volume becomes a positive value from a negative value. Since the carbon nanotube-elastomer composite material 100 containing the CNT structure 50 having such peaks has a short distance through which thermal radicals 150 generated in the elastomer 30 have moved until they have been captured by the CNT 10, the thermal radicals 150 are effectively captured by the CNT 10 so that it becomes possible to improve the heat resistance.

Moreover, the length of the CNT 10 preferably has 1 μm or more, more preferably, 5 μm or more, and further more preferably, 10 μm or more. Since the CNT 10 having such a long length has many joined points between CNTs, it is possible to form a network structure having superior shape retaining property. Additionally, in the present invention, any CNT may be used as long as it has such a long length, and the production method or the like thereof is not particularly limited.

### (Sealing Material and Sheet Material)

The carbon nanotube-elastomer composite material 100 relating to the present invention is desirably used as a sealing material and a sheet material in which its heat resistance is required. In the carbon nanotube-elastomer composite material 100 relating to the present invention, supposing that a storage modulus at the time when the carbon nanotube-elastomer composite material is maintained at 150° C. for t hours is E′(t), a ratio E′ (24)/E′(0) between a storage modulus E′(0) at the time of t=0 hour and a storage modulus E′(24) at the time of t=24 hours is set in a range from 0.5 or more to 1.5 or less so that it can be desirably used as a sealing material and a sheet material even under high temperatures.

Moreover, in the carbon nanotube-elastomer composite material 100 relating to the present invention, a radical concentration is obtained by maintaining the carbon nanotube-elastomer composite material 100 for 10 minutes at either of a lower temperature between 280° C. and a temperature subtracting 50° C. from a thermal decomposition temperature of the elastomer 30 (the thermal decomposition temperature of the elastomer 30-50° C.) and measuring by an ESR method, and relative to the above-mentioned radical concentration, a ratio of a radical concentration that is obtained by measuring the above-mentioned carbon nanotube-elastomer composite material 100 after a lapse of 10 minutes from the time at which the carbon nanotube-elastomer composite material 100 has been returned to room temperature is set to 0.8 or more so that the thermal radicals 150 can be fixed onto the surface of the CNT 10. Therefore, since cutting of molecular chains of the elastomer 30 by the thermal radicals 150 hardly progresses, the resulting material can be continuously used as a sealing material and a sheet material to be used under high temperatures.

The carbon nanotube-elastomer composite material 100 relating to the present invention may be used as an endless seal member. The endless seal member has an endless shape with its external shape continuously formed. The endless seal member is not only provided with a round shape in its external shape, but also formed in accordance with the shape of a groove or a member on which the seal material is disposed. As the endless seal member, for example, an O-ring having a round shape in its lateral cross-section or an X-ring, may be used. The carbon nanotube-elastomer composite material 100 may be used as a dynamic seal, such as, for example, rotation axis seal, reciprocally moving seal, rod seal, piston seal, and the like. Alternatively, it may be also used as a static seal, such as, for example, a gasket.

### (Elastomer)

The elastomer 30 contained in the carbon nanotube-elastomer composite material 100 is not particularly limited, as long as it has a thermally decomposition temperature of 150° C. or more. The elastomer 30 is preferably a thermoplastic elastomer or rubber. In particular, it is preferably fluoro-rubber having high heat resistance (binary fluoro-rubber, ternary fluoro-rubber). As the elastomer 30, examples thereof include elastomers, such as natural rubber (NR), epoxidized natural rubber (ENR), styrene-butadiene rubber (SBR), nitrile rubber (NBR), chloroprene rubber (CR), ethylene-propylene rubber (EPR, EPDM), butyl rubber (IIR), chlorobutyl rubber (CIIR), acrylic rubber (ACM), silicone rubber (Q), fluoro-rubber (FKM), butadiene rubber (BR), epoxidized butadiene rubber (EBR), epichlorohydrin rubber (CO, CEO), urethane rubber (U), polysulfide rubber (T) and the like; thermoplastic elastomers, such as olefin-based (TPO), polyvinyl chloride-based (TPVC), polyester-based (TPEE), polyurethane-based (TPU), polyamide-based (TPEA) and styrene-based (SBS) elastomers; and mixtures of these. Moreover, the elastomer 30 may further contain additives and the like, such as a crosslinker, a crosslinking initiator, an oxidation inhibitor, etc.

### (Production Method)

The following description will discuss a production method for the above-mentioned carbon nanotube-elastomer composite material relating to the present invention. Additionally, the production method to be explained below is exemplary only, and the production method for the carbon nanotube-elastomer composite material relating to the present invention is not intended to be limited thereby.

The production method of the carbon nanotube-elastomer composite material relating to the present invention, which is different from the conventional production method, is characterized by having a process for fibrillating the CNTs to be combined with an elastomer and another process in which a curing agent is added to the carbon nanotube-elastomer composite material by using open rolls to be distributed so that a molded body is obtained, in a separated manner. By using these two processes, it is possible to form a network having continuous CNTs with a large specific surface area having a high capturing effect of thermal radicals in the elastomer and consequently to improve its heat resistance. That is, when a strong shearing force is applied to the CNTs, both of fibrillation in which the bunch (bundle) of the CNTs is released and cutting of the CNTs occurs. In order to form a highly developed continuous network structure of CNTs, it is necessary to obtain CNT having a high aspect ratio by fibrillating CNT without cutting the CNT. Moreover, when CNTs are mixed into rubber, the CNTs may be aggregated because surface energies between the CNT and rubber are different from each other. When the CNT is aggregated, it is not possible to obtain a highly developed continuous network structure of the CNTs. Therefore, by distributing (disposing) the CNTs as roughly as possible from the positional point of view, the network structure is constructed. By the continuous network structure, thermal radicals that lower the molecular weight of rubber can be effectively captured and stabilized.

In the carbon nanotube-elastomer composite material relating to the present invention, in order to improve the capturing effect of radicals, it is necessary to allow the CNT to have many interfaces in the elastomer. For this purpose, it is important to have the CNTs not bundled but fibrillated. In this case, “fibrillate” means that fibers are unraveled. The expression “unravel” means that the CNT has its surface measurable by a gas adsorption method exposed from the bundle thereof.

Moreover, in the present invention, it is important to have the CNTs not aggregated in one place, but distributed uniformly in the elastomer. In order to capture thermal radicals within small moving distances, the CNTs need to be uniformly distributed in the elastomer. Moreover, by making the CNTs physically in contact with one another, the stabilizing energy at the time of capturing thermal radicals can be made greater.

“Fibrillation” refers to the fact that the CNTs are unraveled from a bundle state (bundle) into respective fibers one by one. Many of the CNTs are present as bundles each composed of 10 to 100 fibers immediately after synthesized. In this state, since the surfaces of the CNTs are made in contact with one another among mutual CNTs, it is not possible to improve the heat resistance in the bundle state, as it is. Therefore, the “fibrillation” needs to be carried out so as to make the bundle of the CNTs unraveled, thereby increasing the interface area between the CNT and rubber. In the evaluation method of the “degree of fibrillation”, the CNT rubber is heated at 500° C. for 24 hours under introduction of nitrogen to sublimate the rubber so that only the CNT is taken out. Next, the diameter of the CNT bundle contained in the CNT structure is observed by an SEM or a TEM so that the average diameter D of an arbitrary CNT bundle contained in the rubber is calculated. In the calculation of the average diameter, it is preferable to observe 20 or more bundles. Next, by using a TEM, the diameter Do per piece of the CNT is determined.

The degree of fibrillation De is calculated by:

De=D/D0×100

The degree of fibrillation is preferably set to 1 or more, more preferably, to 10 or more, further more preferably, to 50 or more, and most preferably, to 75 or more.

The CNT to be used for producing the carbon nanotube-elastomer composite material relating to the present invention may be produced by using methods disclosed by, for example, International Publication No. 2006/011655 (single-walled CNT), International Publication No. 2012/060454 (multi-walled CNT) and Japanese Translation of PCT International Application Publication No. 2004-526660 (multi-walled CNT). Since the CNT produced by these production methods has a small diameter and few numbers of layers, it has a very large specific surface area. For this reason, the area in the elastomer capable of capturing radicals becomes large to improve the heat resistance of the carbon nanotube-elastomer composite material, thereby being desirably used.

### (CNT Drying Process)

Although the CNT is formed as an aggregate, the CNTs are mutually adhered to one another due to surface tension of water in a state where moisture is adsorbed thereon, and the CNTs becomes hardly unraveled, failing to provide superior dispersibility in the elastomer. By heating the CNT to 180° C. or more, preferably, 200° C. or more, this is maintained at 10 Pa or less, preferably, 1 Pa or less, for 24 hours or more, preferably, 72 hours or more, so that the moisture adhered onto the surface of the CNT is removed. By removing the moisture on the CNT surface, it becomes possible to improve wettability to a solvent in the next process so that the fibrillating process can be easily carried out. Thus, the network structure of the CNT can be easily formed so that it becomes possible to increase the area of the interface relative to the elastomer capable of capturing thermal radicals in the carbon nanotube-elastomer composite material, and consequently to improve the heat resistance thereof.

### (Classifying Process)

By setting the size of the CNT aggregate within a predetermined range, the CNT aggregate is preferably set to have a uniform size. The CNT aggregate also includes a synthesized product having a lump shape with a large size. Since the lump-shaped CNT aggregate having a large size has a different dispersibility, the dispersibility is lowered. Therefore, when only the CNT aggregates which have passed through a net, filter, mesh or the like and from which the large lump-shaped CNT aggregates have been excluded, are used in processes thereafter, the dispersibility of the CNT in the carbon nanotube-elastomer composite material can be improved.

### (Pre-Dispersion Process)

When the CNT having a large aggregated lump shape, as it is, is loaded into a dispersing machine, this tends to cause clogging; therefore, an organic solvent is added to a dried CNT so that by fibrillating the CNT into a bundle having a size of about 10 μm or less, the yield in the dispersion process can be improved. The pre-dispersion process is, for example, carried out by stirring the CNT of 0.1 parts by weight, prepared by being added to an organic solvent, at 500 rpm or more by using a cross-head stirrer for 8 hours or more. As the organic solvent in which the CNT is dispersed, for example, MIBK may be used. By carrying out the pre-dispersion process, the fibrillating can be more easily carried out in the fibrillating process that is the succeeding process. As the fibrillation progresses, since the apparent specific surface area of the CNT, that is, the interface between the CNT and the elastomer that can be used for capturing radicals, increases, the heat resistance of the carbon nanotube-elastomer composite material is improved.

### (CNT Fibrillating Process)

The CNT is fibrillated in an organic solvent such as MIBK. The conventionally known dispersing method may be adopted; however, in particular, by using a device that disperses the CNT by using a shearing force in a turbulent flow state, such as a jet mill or the like, the CNT can be fibrillated while reducing damages to the CNT. In particular, in a wet-type jet mill, a mixture in a solvent is formed into a high-speed flow, and this is put into a pressure-proof container in a tightly closed state, and press-fed from a nozzle. The CNTs are dispersed by collision between opposing currents inside the pressure-proof container, collision against the container wall, and turbulent flows, shearing flows or the like generated by the high-speed flow. In the case when, as the wet-type jet mill, for example, a nano-jet pal (JN10, JN100, or JN1000) made by JOKOH CO., LTD., is used, the processing pressure in the dispersing process is preferably set at a value within a range from 10 MPa or more to 150 MPa or less.

Upon applying a shearing force by a pressure higher than that described above, the CNT is cut in a fiber axial direction. This fact has been confirmed by Raman spectrometry for use in evaluating defects in the CNT. Moreover, in the case of a pressure of 10 MPa or less, it is not possible to efficiently fibrillate the CNTs. That is, by applying a pressure of 10 MPa to 150 MPa, fibrillating rather than cutting progresses in the CNTs to provide a higher aspect ratio. This high aspect ratio is required for allowing the CNT to construct a highly developed continuous network structure. Moreover, in the present embodiment, in the dispersing process of the CNT aggregate, a jet mill (HJP-17007) made by Sugino Machine Limited may be used.

By fibrillating the CNTs to about 100 nm or less, it becomes possible to increase the area of the interface between the CNT and the elastomer in the carbon nanotube-elastomer composite material. As the specific surface area becomes larger, the capability of capturing radicals causing thermal decomposition of the elastomer can be improved, thereby making it possible to improve the heat resistance in the carbon nanotube-elastomer composite material.

### (Elastomer Kneading Process)

An appropriate amount of an elastomer is added to the CNT dispersion solution thus obtained so as to form a CNT-elastomer solution. By adjusting the added amounts of the elastomer, the concentration of a final CNT can be adjusted. The elastomer kneading process may be carried out by using operations in which, for example, the elastomer is added to the CNT dispersion solution and this is mixed by using a cone-shaped magnet agitator in a beaker. In this case, it is preferable to mix this at 100 rpm or more at room temperature for 12 hours or more, and also to knead the fibrillated CNT and the elastomer. By using an organic solvent having high affinity (having closer solubility parameters) to the CNT and the elastomer, the CNTs and the elastomer are uniformly distributed. As a result, it becomes possible to efficiently fix thermal radicals generated in the elastomer region onto the CNT surface and consequently to improve the heat resistance of the carbon nanotube-elastomer composite material.

### (Solvent Removing Process)

The organic solvent used in the CNT dispersion is removed. At this time, by using an organic solvent having high affinity (having closer solubility parameters) to the CNT and the elastomer, the CNT and the elastomer can maintain uniform structures, without being phase-separated even in a solvent evaporation process. In the solvent removing process, the beaker containing the CNT-elastomer solution therein is maintained on a plate (for example, iron plate), for example, at a temperature of 80° C. (or a temperature of 10° C. or more to 50° C. or less than the boiling temperature of the organic solvent) so that the organic solvent is removed to a certain degree. Moreover, by maintaining it at a low temperature of 20° C. or more to 50° C. or less than the boiling temperature of the organic solvent by using a vacuum oven, the organic solvent can be completely removed. Since the organic solvent causes deterioration of the elastomer, it is important to positively remove the organic solvent so as to improve the heat resistance of the carbon nanotube-elastomer composite material. Thus, a carbon nanotube-elastomer master batch can be obtained.

### (Kneading by Open Roll)

The carbon nanotube-elastomer master batch is kneaded by using open rolls. The temperature of the rolls is preferably set to 20° C. or more lower than the crosslinking start temperature and 50° C. or more higher than room temperature. Moreover, the ratio of the number of rotations of the rolls is set to 1.2 or less, preferably, to 1.15 or less, more preferably, to 1.1 or less. In general, in the open rolls, as the temperature becomes lower and the ratio of rotation numbers becomes higher, a higher shearing force can be applied so that the material can be well kneaded; however, in the present process, the master batch is kneaded by using a slow shearing force at high temperature with a low rotation ratio. By setting the roll temperature as high as possible, the viscosity of the elastomer is lowered to reduce the shearing force applied to the CNT. Moreover, by setting the rotation ratio to 1.2 or less, the shearing force to be applied to the CNT is lowered so that the shortened length of the CNT by the cutting is desirably suppressed. As a result, since the CNT forms a continuous network structure capable of efficiently capturing thermal radicals, the heat resistance of the carbon nanotube-elastomer composite material can be improved. At this time, a crosslinker, a crosslinking initiator and other additives may be added thereto.

A thin film is allowed to pass through the resulting carbon nanotube-elastomer composite material so that a sheet-shaped material containing the CNT, elastomer, and other additives therein can be obtained. The sheet-shaped material is filled into a metal mold or the like, and heated while being pressed by a hot press or a vacuum press so as to be molded. At this time, the crosslinking operation may be carried out. By carrying out the molding process, the material can be shaped into a sealing material or the like, and moreover, by carrying out the crosslinking operation, a three-dimensional crosslinking process is carried out so that the heat resistance can be improved.

### EXAMPLES

### Example 1

By using a single-walled CNT produced by the method described in Japanese Translation of PCT International Application Publication No. 2006/011655 and fluoro-rubber (Daiel-G912, made by Daikin Industries, Ltd.), a carbon nanotube-elastomer composite material of Example 1 was produced. Based upon observations made by a TEM, the single-walled CNT used in Example 1 had a length of 100 μm and an average diameter of 3.0 nm and its number of layers was one. Moreover, by taking out a lump of 50 mg, adsorption/desorption isothermal curves in liquid nitrogen at 77K were measured by using a BELSORP-MINI (made by BEL Japan, Inc.) (adsorption equilibrium time was set to 600 seconds). Based upon these adsorption/desorption isothermal curves, the specific surface area was measured by using a method by Brunauer, Emmett, Teller; thus about 1000 m²/g was obtained.

In the single-walled CNT, the CNT aggregate was placed on one side of a mesh having a sieve opening of 0.8 mm, and by sucking air by using a vacuum cleaner with the mesh interpolated therebetween, those materials passed through the mesh were collected so that lump-shaped CNT aggregates having a large size were removed from the CNT aggregate so as to be classified (classifying process).

The CNT aggregate was measured by a Karl Fischer reaction method (Coulometric titration-type trace moisture measuring device CA-200 type made by Mitsubishi Chemical Analytic Co., Ltd.). After the CNT aggregate had been dried under predetermined conditions (maintained under vacuum at 200° C. for 1 hour), the vacuum state was released in a glove box in a drying nitrogen gas flow, and about 30 mg of the CNT aggregate was taken out, and shifted to a glass boat of a moisture meter. The glass boat was moved to a vaporization device, and then heated at 150° C. for two minutes, and moisture evaporated at this period was carried by a nitrogen gas, and subjected to a reaction with iodine by the Karl Fischer reaction in the neighboring process. Thereafter, based upon an electric quantity required for generating iodine the amount of which was the same as the iodine consumed at that time, the moisture amount was detected. By this method, the CNT aggregate before the drying process contained moisture of 0.8% by weight. After the drying process, the moisture of the CNT aggregate was reduced to 0.3% by weight.

The classified CNT aggregate (100 mg) was precisely measured, and loaded into a 100 ml flask (with three necks: for vacuum and for temperature adjustment), and after having been heated to reach 200° C. under vacuum, this was maintained for 12 hours so as to be dried. After the drying process, while being kept in heating/vacuum processing state, to this was injected 20 ml of a dispersion medium MIBK (methyl isobutyl ketone) (made by Sigma-Aldrich Co., LLC.) at a temperature of 100° C. or more, and the CNT aggregate was prevented from being exposed to the atmosphere (drying process).

Moreover, to this was further added MIBK (made by Sigma-Aldrich Co., LLC.) to reach 300 ml. An agitator was put to the beaker, and the beaker was sealed by aluminum foil so as to prevent the MIBK from being evaporated, and stirred by a stirrer at 600 rpm for 12 hours at room temperature.

In the dispersion process, by using a wet-type jet mill (wet-type jet mill (HJP-7000) made by Sugino Machine Limited Co., Ltd.), and the mixture was allowed to pass through a passage of 0.13 mm at a pressure of 100 MPa, and by allowing this to further pass through the passage at a pressure of 120 MPa, the CNT aggregate was dispersed in the MIBK so that a CNT dispersion solution having a weight concentration of 0.033 parts by weight was obtained.

The CNT dispersion solution was further stirred by a stirrer for 24 hours at room temperature. At this time, the solution was heated to 70° C. so that the MIBK was evaporated to set the amount to about 150 ml. The weight concentration of the CNT at this time became about 0.075 parts by weight (dispersion process). Thus, the CNT dispersion solution according to the present invention was obtained.

In the present example, fluoro-rubber (Daiel-G912, made by Daikin Industries, Ltd.) was used as a compound containing fluorine. In the case when the weight of the entire carbon nanotube-elastomer composite material was set to 100 parts by weight, 100 mg of the fluoro-rubber was added to 100 ml of the CNT dispersion solution so as to set the CNT content to 1 part by weight, with the fluoro-rubber content being set to 99 parts by weight, and this was stirred at room temperature for 16 hours under the condition of about 300 rpm so as to concentrate the entire amount to about 50 ml.

The sufficiently mixed solution was poured into a beaker or the like, and dried at 80° C. for 2 days. Moreover, this was further put into a vacuum drying furnace of 80° C., and dried for 2 days so that the organic solvent was removed, thereby obtaining a master batch.

Twin rolls (ø6″×L15 test roll machine, front and rear independent variable speed, made by Kansai Roll Co., Ltd.) were used, and the master batch was wound around the rolls. The temperature of the rolls was 70° C., the rotation speed ratio was 1.2, the front wheel rotation speed was 23.2 rpm, the rear wheel rotation speed was 18.9 rpm, and the roll interval was set to 0.5 mm. While the sample was allowed to thinly pass through the rolls, a crosslinker (triallyl isocyanurate (TAIC), 4 phr) and a crosslinking initiator (perhexa 25B, 1.5 phr) were added thereto. Thereafter, by using a metal mold, this was heated and molded at 270° C. for 10 minutes, and by further carrying out a heating process at 180° C. thereon for 4 hours or more, the crosslinking was further progressed so that a carbon nanotube-elastomer composite material of Example 1 was obtained.

### Example 2

In Example 2, by using the same single-walled CNT (hereinafter, referred to also as SG-SWNT) as that of Example 1, the contents were altered. By using the SG-SWNT (0.1 part by weight) and ternary fluoro-rubber (FKM) (Daiel-G912, made by Daikin Industries, Ltd.), the same method as that of Example 1 was carried out so that a carbon nanotube-elastomer composite material of Example 2 was produced.

### Example 3

By using the SG-SWNT (10 parts by weight) and ternary FKM (Daiel-G912, made by Daikin Industries, Ltd.), the same method as that of Example 1 was carried out so that a carbon nanotube-elastomer composite material of Example 3 was produced.

### Example 4

In Example 4, as the multi-walled CNT, Nanocyl having 5 to 10 graphene layers was used. By using Nanocyl-MWNT (5 parts by weight) and ternary FKM (Daiel-G912, made by Daikin Industries, Ltd.), the same method as that of Example 1 was carried out so that a carbon nanotube-elastomer composite material of Example 4 was produced.

### Example 5

In Example 5, as the multi-walled CNT, CNano having 5 to 10 graphene layers was used. By using CNano-MWNT (5 parts by weight) and ternary FKM (Daiel-G912, made by Daikin Industries, Ltd.), the same method as that of Example 1 was carried out so that a carbon nanotube-elastomer composite material of Example 5 was produced.

### Example 6

In Example 6, as the elastomer, binary fluoro-rubber (FKM) was used. By using SG-SWNT (1 part by weight) and binary FKM (Daiel-G801, made by Daikin Industries, Ltd.), the same method as that of Example 1 was carried out so that a carbon nanotube-elastomer composite material of Example 6 was produced.

### Example 7

In Example 7, as the elastomer, hydrogenated nitrile rubber (H-NBR) was used. By using SG-SWNT (1 part by weight) and H-NBR (hydrogenated nitrile rubber, Zetpol 2020, made by Zeon Corporation), a composite material production was carried out. In the present system, as the crosslinking material, 1.5 phr of perhexa 25B was added thereto to carry out the crosslinking process (with no TAIC added thereto).

### Example 8

In Example 8, as the elastomer, acrylic rubber (ACM) was used. By using SG-SWNT (1 part by weight) and ACM (acrylic rubber, Nipol AR31, made by Zeon Corporation), a composite material production was carried out. In the present system, as the crosslinking material, 1.5 phr of perhexa 25B was added thereto to carry out the crosslinking process (with no TAIC added thereto).

### Comparative Example 1

In Comparative example 1, carbon black was used in place of CNT. By using CB (MAF, 10 parts by weight, made by Tokai Carbon Co., Ltd.) and ternary FKM (Daiel-G912, made by Daikin Industries, Ltd.), the same method as that of Example 1 was carried out so that a carbon nanotube-elastomer composite material of Comparative example 1 was produced.

### Comparative Example 2

In Comparative example 2, carbon fibers (CF) were used in place of CNT. By using pitch-based carbon fibers (Dialead, 200 μm, 10 parts by weight, made by Mitsubishi Chemical Corporation) and ternary FKM (Daiel-G912, made by Daikin Industries, Ltd.), the same method as that of Example 1 was carried out so that a carbon nanotube-elastomer composite material of Comparative example 2 was produced.

### Comparative Example 3

As Comparative example 3, a sample was produced by using only the elastomer. By adding TAIC and perhexa 25B to ternary FKM simple substance, the sample of Comparative example 3 was produced.

### (Molding and Processing of Carbon Nanotube-Elastomer Composite Material)

Each of the carbon nanotube-elastomer composite materials of Examples 1 to 8 and Comparative examples 1 to 3 was put into a metal mold, and gas releasing processes were carried out three times in the vacuum hot pressing process. In the vacuum oven, this was maintained at 170° C. for 15 minutes, and was then maintained at 180° C. for 4 hours in a gear oven (atmospheric pressure). A sealing material and a sheet-shaped material composed of the carbon nanotube-elastomer composite material were obtained.

### (Measurements of CNT Added Amount)

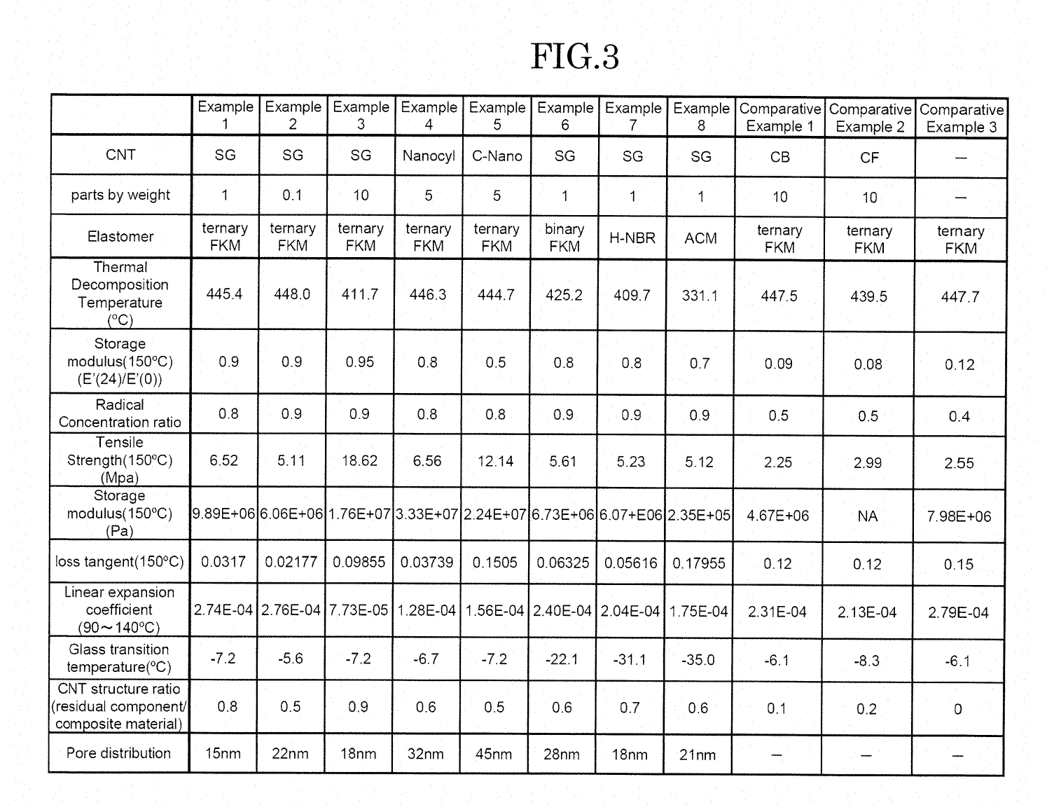

With respect to the carbon nanotube-elastomer composite materials of the Examples and Comparative examples, the added amount of CNT was measured by the following method. By using a differential heat/thermogravimetry simultaneous measuring apparatus (TG/DTA, STA7000, made by Hitachi High-Technologies), measurements were carried out. In a primary temperature-raising process, while supplying 200 ml/min of nitrogen thereto, the material temperature was raised from room temperature to 800° C. at 1° C./min. In the primary temperature-raising process, only the elastomer was sublimated to leave CNT as a residual component. In the case when carbon fillers or the like other than the CNT were contained, a secondary temperature-raising process was carried out. In the secondary temperature-raising process, while supplying 200 ml/min of pure air thereto, the material temperature was raised from room temperature to 800° C. at 1° C./min. In the pure air, the CNT and carbon fillers were burned at conventionally known temperatures to cause a weight reduction. Based upon the weight reduction, the CNT filling amount was calculated. FIG. 3 shows the results of measurements of the CNT added amount.

### (Thermal Decomposition Temperature)

With respect to the carbon nanotube-elastomer composite materials of the Examples and Comparative examples, the thermal decomposition temperature was measured by the following method. By using a differential heat/thermogravimetry simultaneous measuring apparatus (TG/DTA, STA7000, made by Hitachi High-Technologies), measurements were carried out. While supplying 200 ml/min of nitrogen thereto, the material temperature was raised from room temperature to 800° C. at 1° C./min. With the maximum value of ΔW/ΔT being set as a thermal decomposition temperature (TG), the thermal decomposition temperature was calculated. In this case, W represents a sample weight, and T represents a temperature. FIG. 3 shows the results of measurements of the CNT added amount.

### (Storage Modulus and Loss Tangent)

With respect to each of the carbon nanotube-elastomer composite materials of the Examples and Comparative examples, the storage modulus and loss tangent were measured by using the following method. Measurements were carried out by using a dynamic viscoelasticity measuring device (RSA2000, made by TA instruments). While supplying nitrogen thereto at 200 ml/min, the material was temperature-raised from room temperature to the glass transition point (TG)—50° C. at 10° C./min.

Supposing that a storage modulus at the time when the carbon nanotube-elastomer composite material is maintained at 150° C. fort hours is E′(t), a ratio E′ (24)/E′(0) between a storage modulus E′ (0) at the time of t=0 hour and a storage modulus E′(24) at the time of t=24 hours was calculated. The rate of change of the storage modulus is shown in FIG. 3. It is clearly indicated that in the carbon nanotube-elastomer composite material of the Examples, the rate of change of the storage modulus was 0.5 or more, and that even in the case when continuously used for 24 hours or more at a temperature of 150° C. or more, the change in the storage modulus was small. On the other hand, it is also clearly indicated that in the carbon nanotube-elastomer composite material in the Comparative examples, the rate of change in the storage modulus was around 0.1, and that the storage modulus was extremely lowered when continuously used under a high temperature condition.

Moreover, when the carbon nanotube-elastomer composite material of the Examples is heated by a dynamic mechanical characteristic measuring device from room temperature at a rate of 10° C./min, the storage modulus at 150° C. was set to 0.5 MPa or more, and the loss tangent thereof was set to 0.5 or less. On the other hand, in the carbon nanotube-elastomer composite material of the Comparative examples, the storage modulus was set to 0.1 or less.

### (Radical Concentration)

With respect to each of the carbon nanotube-elastomer composite materials of the Examples and Comparative examples, the radical concentration was measured by using the following method. A JES-FE3T made by JEOL Ltd. was used as an ESR measuring device, and an ES-HEXA (made by JEOL Ltd.) was used as a temperature cavity. The temperature was set to 20° C. to 280° C., the central magnetic field was set to 3277G, the magnetic field sweep width was set to 200G, and the modulated frequency was set to 100 kHz, with 4G. The microwave was set to 9.21 GHz with 1 mW, and the number of data points was 4095 points. A TE011 having a cylindrical shape was used as the cavity. Before the temperature rise, the radical concentration was measured, and after having been maintained at 280° C. for 10 minutes, this was returned to room temperature, and after a lapse of 10 minutes, measurements were carried out at three points. A concentration ratio of radicals between that at 280° C. and that returned to room temperature was calculated.

FIG. 3 shows the results of measurements of the radical concentration. In the case of the carbon nanotube-elastomer composite material of the Examples, the radical concentration ratio becomes 0.8 or more, thereby it is clearly indicated that thermal radicals are fixed onto the CNT to be no longer movable. On the other hand, in the case of the carbon nanotube-elastomer composite material of the Comparative examples, the radical concentration ratio becomes 0.5 or less, which is a small value, thereby it is clearly indicated that thermal radicals are not fixed onto the CNT.

### (Tensile Strength)

With respect to the carbon nanotube-elastomer composite materials of the Examples and Comparative examples, the tensile strength was measured by the following method. By using a precise versatile tester that is, a tensile tester (Autograph, AG-1 kN), measurements were carried out. The sample was maintained at 150° C. in a thermostatic chamber. The measurements were carried out based upon JIS K 6251.

The results of tensile strength measurements are shown in FIG. 3. In the carbon nanotube-elastomer composite materials of the Examples, the tensile strength in the tensile test (in compliance with JIS K6251) became 1 MPa or more, and it was found that even under high temperatures, the rubber elasticity inherent to the elastomer can be maintained. On the other hand, in the case of the carbon nanotube-elastomer composite materials of the Comparative examples, it became smaller than 1 MPa, thereby causing a liquid state.

### (Linear Expansion Coefficient)

With respect to the carbon nanotube-elastomer composite materials of the Examples and Comparative examples, the linear expansion coefficient was measured by the following method. By using a thermo-mechanical analyzer (TMA/SS) (TMA7000, made by Hitachi High-Technologies Corporation), measurements were carried out. While supplying 200 ml/min of nitrogen thereto, the linear expansion coefficient of each of the samples was measured, with the temperature being raised at a temperature raising rate of 5° C./min, with the pushing pressure being set to 50 μg.

The results of measurements of the linear expansion coefficient are shown in FIG. 3. In the carbon nanotube-elastomer composite materials of the Examples, the linear expansion coefficient was 5×10⁻⁴/K or less so that it was found that even a sealing material attached at room temperature is not slackened by a thermal expansion, and can be used even at high temperatures. On the other hand in the case of the carbon nanotube-elastomer composite material of the Comparative examples, it was found that the thermal expansion coefficient exceeds 5×10⁻⁴/K and it is slackened by a thermal expansion.

### (Glass Transition Temperature)

The glass transition temperature was measured by using a differential scanning calorimeter (DSC 7020, made by Hitachi High-Technologies Corporation). A sample (about 10 mg) was sealed in a sample pan made of aluminum, and temperature variations in the specific heat capacity were measured, while the temperature was raised at 5° C./min from −70° C. The temperature at which the specific heat capacity has first started to significantly change after a temperature rise is defined as “glass transition temperature”.

### (Volume Measurements of CNT Structure)

With respect to the carbon nanotube-elastomer composite materials of the Examples and Comparative examples, the CNT volume was measured by the following method. A sample was set in a tube-shaped furnace, and this was subjected to a heating treatment at 500° C. for 6 hours under a nitrogen atmosphere so that matrix components were removed by thermal decomposition. With respect to the volume of the CNT structure, the thickness and lengths of the respective sides of the sample having a sheet shape were measured by a micrometer, and by multiplying these values, the volume was found.

FIG. 3 shows the results of volume measurements of the CNT structure. In the case of the carbon nanotube-elastomer composite material of the Examples, the ratio of the bulk volume of a CNT structure 50 formed by the residual CNT 10 after the burning process relative to the volume of the carbon nanotube-elastomer composite material 100 prior to the burning process was set to 0.5 or more such that it was found that the CNTs 10 were made in contact with one another in the elastomer to consequently form a network having a dynamic holding force. On the other hand, in the case of the carbon nanotube-elastomer composite material of the Comparative examples, the ratio of the volumes was 0.2 or less, with the result that the network was not sufficiently formed, thereby failing to provide the dynamic holding force.

### (Pore Distribution of CNT Structure)

With respect to the carbon nanotube-elastomer composite materials of the Examples and Comparative examples, the pore distribution of the CNT structure was measured by the following method. The sample was set in a tube-shaped furnace, and subjected to a heating treatment at 500° C. for 6 hours, under a nitrogen atmosphere so that the matrix components were removed by thermal decomposition. The distribution of pore diameters of the obtained CNT residual matters was measured by a mercury porosimeter (PoreMaster 60GT made by Quantachrome Instruments). The measurements were carried out in compliance with Washburn method, with the mercury pressure being varied from 1.6 kPa to 420 MPa.

The pore distribution of the CNT structure is shown in FIG. 3. In the carbon nanotube-elastomer composite materials of the Examples, when maintained under a nitrogen atmosphere at 500° C. for 6 hours or more, with respect to the pore distribution in the residual CNT structure 50, one or more peaks were found in a range from 1 nm or more to 100 μm or less so that it was found that thermal radicals generated in the elastomer had a short distance to move until they had been captured by the CNT.

In accordance with the present invention, by making an elastomer and carbon nanotubes combine with each other, it is possible to improve heat resistance of the elastomer, and consequently to provide a carbon nanotube-elastomer composite material capable of being continuously used for 24 hours or more at a temperature of 150° C. or more, and also to provide a sealing material and a sheet material each produced using the same.

1. A carbon nanotube-elastomer composite material comprising carbon nanotubes and an elastomer,
wherein the carbon nanotubes are contained in an amount from 0.1 part by weight or more to 20 parts by weight or less relative to the total weight of the carbon nanotubes and the elastomer,
the elastomer has a thermal decomposition temperature of 150° C. or more, and
supposing that the resulting storage modulus is E′(t) when the carbon nanotube-elastomer composite material is maintained at 150° C. for t hours, a ratio E′ (24)/E′(0) between a storage modulus E′ (0) at the time of t=0 hour and a storage modulus E′(24) at the time of t=24 hours is set in a range from 0.5 or more to 1.5 or less.

2. The carbon nanotube-elastomer composite material according to claim 1, wherein a radical concentration of the carbon nanotube-elastomer composite material is obtained by maintaining the carbon nanotube-elastomer composite material for 10 minutes at either of a lower temperature between 280° C. and a temperature subtracting 50° C. from a thermal decomposition temperature of the elastomer and measuring by an electron spin resonance method, and a value, which is obtained by dividing the radical concentration by a radical concentration obtained by measuring the nanotube-elastomer composite material by the electron spin resonance method after a lapse of 10 minutes from the time at which the carbon nanotube-elastomer composite material has been returned to room temperature, is set to 0.8 or more.

3. A carbon nanotube-elastomer composite material comprising carbon nanotubes and an elastomer,
wherein the carbon nanotubes are contained in an amount from 0.1 part by weight or more to 20 parts by weight or less relative to the total weight of the carbon nanotubes and the elastomer,
the elastomer has a thermal decomposition temperature of 150° C. or more, and
a radical concentration of the carbon nanotube-elastomer composite material is obtained by maintaining the carbon nanotube-elastomer composite material for 10 minutes at either of a lower temperature between 280° C. and a temperature subtracting 50° C. from a thermal decomposition temperature of the elastomer and measuring by an electron spin resonance method, and a value, which obtained by dividing the radical concentration by a radical concentration that is obtained by measuring the nanotube-elastomer composite material by the electron spin resonance method after a lapse of 10 minutes from the time at which the carbon nanotube-elastomer composite material has been returned to room temperature, is set to 0.8 or more.

4. The carbon nanotube-elastomer composite material according to claim 1, wherein the tensile strength measured in a tensile strength test (in compliance with JIS K6251) at 150° C. of the carbon nanotube-elastomer composite material is set to 1.0 MPa or more.

5. The carbon nanotube-elastomer composite material according to claim 1, wherein, when the carbon nanotube-elastomer composite material is heated by a dynamic mechanical characteristic measuring device from room temperature at a rate of 10° C./min, the storage modulus at 150° C. is set to 0.5 MPa or more, and the loss tangent thereof is set to 0.5 or less.

6. The carbon nanotube-elastomer composite material according to claim 1, wherein in a range from room temperature to 150° C., the carbon nanotube-elastomer composite material has a linear expansion coefficient of 5×10⁻⁴/K or less.

7. The carbon nanotube-elastomer composite material according to claim 1, wherein the carbon nanotube-elastomer composite material has a glass transition temperature measured by differential scanning calorimetry in a range from −50° C. or more to 10° C. or less.

8. The carbon nanotube-elastomer composite material according to claim 1, wherein the carbon nanotubes have a specific surface area of 200 m²/g or more.

9. The carbon nanotube-elastomer composite material according to claim 1, wherein the carbon nanotubes have a diameter of 20 nm or less.

10. The carbon nanotube-elastomer composite material according to claim 1, wherein the number of layers in each of the carbon nanotubes is 10 or less.

11. The carbon nanotube-elastomer composite material according to claim 1, wherein when the carbon nanotube-elastomer composite material is maintained under a nitrogen atmosphere at 500° C. for 6 hours or more, the residual carbon nanotubes form a structure, and
a ratio of the bulk volume of the carbon nanotube structure forming the residual carbon nanotube after the burning process relative to the volume of the carbon nanotube-elastomer composite material before the burning process is 0.5 or more.

12. The carbon nanotube-elastomer composite material according to claim 11, wherein the structure of the residual carbon nanotubes has a pore distribution having one or more peaks in a range of 1 nm or more to 100 μm or less.

13. A sealing material comprising the carbon nanotube-elastomer composite material according to claim 1.

14. A sheet material comprising the carbon nanotube-elastomer composite material according to claim 1.
